(19) United States
(12) Patent Application Publication
(10) Pub. No.: US 2005/0010481 A1
(43) Pub. Date: Jan. 13, 2005

(54) Systems and methods for improving the liquidity and distribution network for illiquid items

(76) Inventors: Howard W. Lutnick, New York, NY (US); Michael Sweeting, Aldershot (GB)

Correspondence Address: FISH & NEAVE LLP, 1251 AVENUE OF THE AMERICAS, 50TH FLOOR, NEW YORK, NY, 10020-1105, US

(21) Appl. No.: 10/615,721

(22) Filed: Jul. 8, 2003

(51) Int. Cl. G06F 17/60

(52) U.S. Cl. 705/26; 705/37

(57) ABSTRACT

Systems and methods that may provide speculators an opportunity to invest in items and markets that, in the past, were not liquid enough to allow for investment by the general public are provided. Systems and methods for creating indices for these items or markets are also provided. One embodiment of the systems and methods of the invention pertains to the trading of futures and/or options contracts based on an intellectual property assets index. This embodiment allows investors to invest in or hedge against the success of failure of a company's of group of companies' intellectual property assets. Another embodiment of the systems and methods of the invention pertains to the trading of futures and/or options contracts based on a bankruptcy index. This embodiment may provide investors with protection from losses associated with the bankruptcy of one or more companies.

### BACKGROUND OF THE INVENTION

This invention relates to the trading of futures and/or options contracts for non-traditionally traded items or markets. One aspect of this invention relates to creating special indices and trading futures and/or options contracts based on these indices.

Historically, futures and options contracts were naturally limited to items and markets that could be directly traded, such as commodities or securities. The ability to trade futures and options contracts for these objects and items has increased their liquidity and has provided hedging methods and strategies.

It would be desirable to have the ability to trade futures and/or options contracts on items or markets that cannot be directly traded. For these items or market, an index can be created that is linked in value to the underlying items or markets. Futures and/or options contracts can then be directly traded based and the value of such an index.

It would be desirable to create a system and method for creating a user configurable index, such as an intellectual property index or a bankruptcy index, and trading futures and/or options contracts based on the value of that index.

### SUMMARY OF THE INVENTION

It is an object of this invention to provide systems and methods according to the invention that may provide speculators an opportunity to invest in items and markets that, in the past, were not liquid enough to allow for investment by the general public. Systems and methods for creating indices for these items or markets can help improve their overall liquidity.

In a system and method according to the invention, a user would be able to purchase or sell futures or options contracts on non-traditionally traded items, markets, or user configurable indices using a computer-based futures and options exchange system. The system may preferably list a number of futures and/or options contracts for a particular index representing items or markets. The user could either select an existing contract or, alternatively, create a new contract around user specified criteria. The user may then view the contract status and execute a trade.

Further systems and methods according to the invention, provide a computer-based system for creating new specialized indices for the items or markets by electronically collecting relevant market information. Relevant market data from various sources could be captured, compiled, sorted, and updated by the computer system to generate a new index for the items or markets. The selection of the relevant market data is preferably automatically made by the system for each individual item or market. Alternatively, the selection of data may be user defined.

### BRIEF DESCRIPTION OF DRAWINGS

Further features of the invention, its nature and various advantages will be apparent from the following detailed description of the preferred embodiments, taken in conjunction with the accompanying drawings, in which like reference characters refer to like parts throughout, and in which:

FIG. 1 is an illustration of an electronic implementation of a system to sell futures and options contracts on an intellectual property assets index in accordance with some embodiments of the present invention;

FIG. 2 is an illustration, in greater detail, of an electronic implementation of a system to sell futures and options contracts on intellectual property assets index in accordance with some embodiments of the present invention; and

FIG. 3 is an illustration of a chart of data for intellectual property asset options contracts in accordance with some embodiments of the present invention.

Skilled artisans will appreciate that in many cases elements in certain FIGs. are illustrated for simplicity and clarity and have not necessarily been drawn to scale. For example, the dimensions of some of the elements in certain FIGs. may be exaggerated relative to other elements to help to improve understanding of what is being shown.

### DETAILED DESCRIPTION OF THE INVENTION

This invention relates to systems and methods that may provide speculators an opportunity to invest in items and markets that, in the past, were not liquid enough to allow for investment by the general public. Systems and methods for creating indices for these items or markets can help improve their overall liquidity. The following embodiment of the invention relates to intellectual property assets. Nevertheless, this embodiment does not limit the invention to this particular subject matter.

The value of intellectual property assets such as patents, copyrights, and trademarks can be used to create tradable securities. The value of these assets are one way to measure the viability and future success of a company. One object of the systems and methods of this invention is to trade futures and/or options contracts based on an intellectual property assets index.

In many technology companies, intellectual property assets are a good predictor of future performance. A robust patent portfolio protecting a key invention can ensure protection from competitors and strong licensing revenues. A weak patent portfolio may indicate the opposite. In some cases the difference between the success and failure of a company may rest on the strength of the company's patent portfolio and other intellectual property assets. Thus the ability to trade futures and options contracts linked to the value of a company's intellectual property assets allows investors to invest in or hedge against the success or failure of a particular company or group of companies.

An index of intellectual property assets may be based on criteria such as: the number of citations to a selected set of patents by a national patent office (e.g., the U.S.P.T.O., the J.P.O., or the E.P.O.), the number of patents issued to an entity by a national patent office, a weighted average of the number of patents issued to an entity by a selected set of national patent offices, a weighted average of ages of patents in a selected portfolio, litigation results, number and quality of citations in litigation proceedings, and licensing contracts and revenues. Any of these criteria, as well as other related criteria, may be used in association with an algorithm to calculate an intellectual property assets index. The number and type of criteria, as well as the algorithm used, may be preset in the system or may be user configurable.

In order to create the intellectual property assets index, the computerized system may electronically capture,—e.g., retrieve and preserve in a lasting form—compile,—e.g., arrange or compose from materials gathered from several sources —sort,—e.g., classify according to a suitable classification system according to class, kind, size, or other suitable criteria—and update this and other relevant data preferably in real time or other suitable pre-determined interval. The result of these systems and methods would be to provide an index of intellectual property assets of a group of companies or an index of intellectual property assets relating to a specified field or subject matter. In a similar way, this system may be used to generate an index for many different non-traditionally traded items or markets, on which futures and options contracts may then be traded.

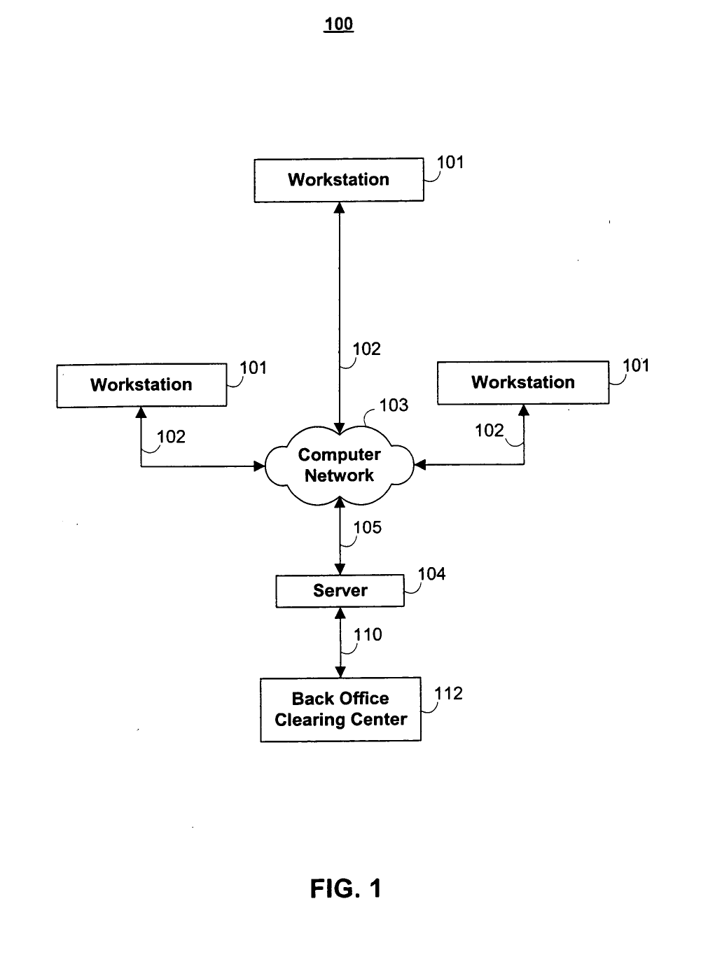

Referring to FIG. 1, exemplary system 100 for implementing the present invention is shown. As illustrated, system 100 may include one or more workstations 101. Workstations 101 may be local or remote, and are connected by one or more communications links 102 to computer network 103 that is linked via communications link 105 to server 104. Server 104 is linked via communications link 110 to back office clearing center 112.

In system 100, server 104 may be any suitable server, processor, computer, or data processing device, or combination of the same. Server 104 may be used to process and settle executed trades of futures and/or options contracts for specialized indices.

Computer network 103 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 102 and 105 may be any communications links suitable for communicating data between workstations 101 and server 104, such as network links, dial-up links, wireless links, hard-wired links, etc.

Workstations 101 may be personal computers, laptop computers, mainframe computers, dumb terminals, data displays, Internet browsers, Personal Digital Assistants (PDAs), two-way pagers, wireless terminals, portable telephones, etc., or any combination of the same. Workstations 101 may be used to enter into and proceed with the trades that relate to the present invention, and display trade, benchmark, or spread information to users of system 100.

Back office clearing center 112 may be any suitable equipment, such as a computer, a laptop computer, a mainframe computer, etc., or any combination of the same, for causing trades to be cleared and/or verifying that trades are cleared. Communications link 110 may be any communications link suitable for communicating data between server 104 and back office clearing center 112, such as network links, dial-up links, wireless links, hard-wired links, etc.

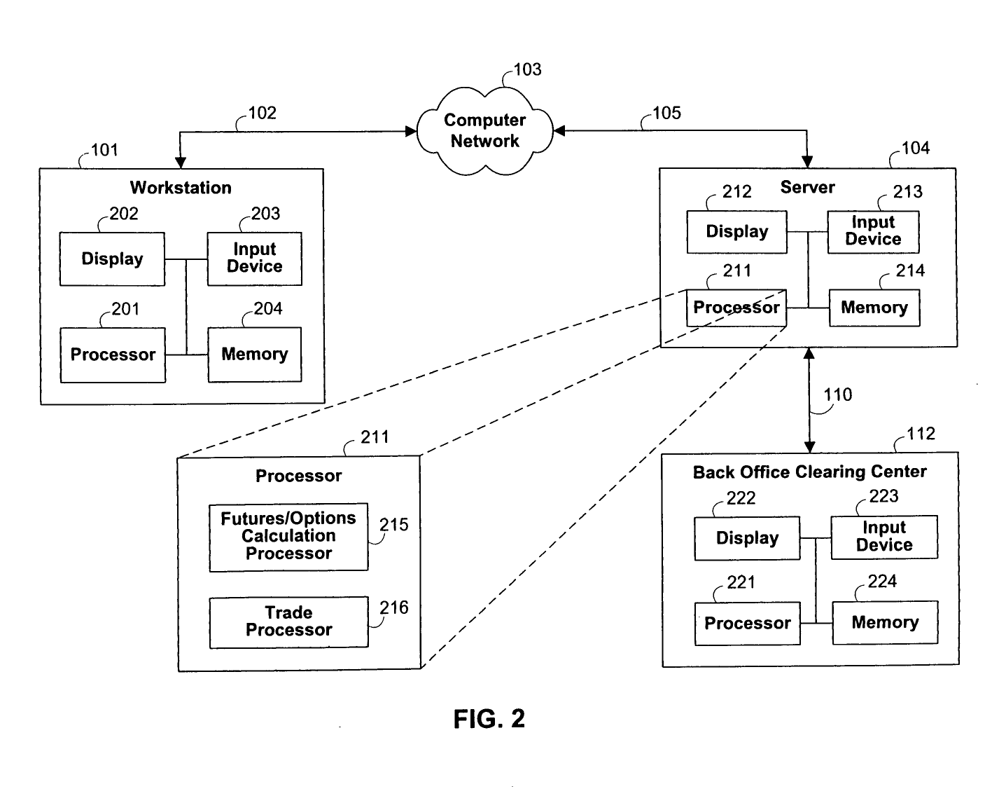

The server, the back office clearing center, and one of the workstations, which are depicted in FIG. 1, are illustrated in more detail in FIG. 2. Referring to FIG. 2, workstation 101 may include processor 201, display 202, input device 203, and memory 204, which may be interconnected. In a preferred embodiment, memory 204 contains a storage device for storing a workstation program for controlling processor 201. Processor 201 may use the workstation program to present on display 202 trade information relating to bids, offers, and executed trades relating to the futures and options contracts for specialized indices to a user of workstation 101. Furthermore, input device 203 may be used by the user to enter such bids and offers, modify them, and to enter into trades involving the futures and options contracts.

Server 104 may include processor 211, display 212, input device 213, and memory 214, which may be interconnected. In a preferred embodiment, memory 214 contains a storage device for storing trade information relating to the trades. The storage device further contains a server program for controlling processor 211. Processor 211 uses the server program to transact the purchase and sale of the futures and/or options contracts.

The server program operative on processor 211 may be made up of a plurality of individual software modules. These modules may all be present on the one server, as in this example, or spread amongst multiple systems. These modules are programmed in such a way as to work collectively to implement the full functionality of server 104. Some of the software modules implement the basic functionality of server 104—i.e., the operating system modules. Other modules may implement the systems and methods of the present inventions—i.e. a futures and options contract trading module or an index creating module including sub-modules to capture, compile, arrange, sort, and update relevant data. Still other software modules may implement the configuration of server 104. Persons skilled in the art will recognize that the use of software modules to describe different parts of the server program is one way of breaking down the program design for easier description and implementation. The systems and methods of the present invention may be implemented without using the modules as described, which are merely representative of one potential embodiment of the server program.

Processor 211 may include futures and/or options calculation processor 215 that may be implemented to determine the benchmark values based on market conditions or other criteria that may relate to the items. Processor 211 may include trade processor 216 that executes and processes trades on the futures and/or options contracts.

Back office clearing center 112 may include processor 221, display 222, input device 223, and memory 224, which may be interconnected. In a preferred embodiment, memory 224 contains a storage device for storing a clearing program for controlling processor 221. Processor 221 uses the clearing program to clear executed trades. Clearing executed trades may preferably include exchanging currency for a future commitment or a future option.

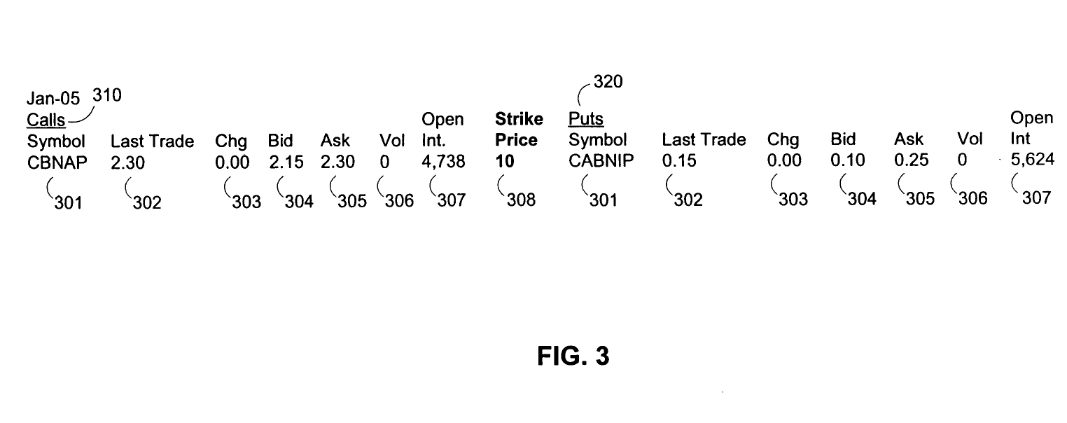

FIG. 3 shows an example of an options screen for the trading of options contracts on intellectual property assets indices. After selecting a particular option, this screen displays relevant market information. The information on the screen may typically include information on Calls 310, which are options to buy futures contracts, as well as Puts 320, which are options to sell futures contracts. For each of these transactions, the screen will contain relevant market data for each item represented by its particular symbol 301. The market data may include such information as the amount paid for the last option 302, the last change in price 303, the highest price being currently offered to buy the option 304, the lowest price for which the option is being sold 305, the volume of shares traded 306, the open interest 307,—i.e., the total number of options contracts traded that have not yet been liquidated—and the strike price—i.e., the stated price per share for which the future may be purchased (in the case of a Call) or sold (in the case of a Put) by the option holder upon exercise of the option contract.

Another embodiment of the systems and methods of the invention is related to a bankruptcy index. A bankruptcy index may be created as a system and method of investing in or hedging against the bankruptcy of a particular group of companies. The system and method comprises creating and permitting investment in futures and/or options contracts based on a bankruptcy index. An options screen for the trading of options contracts on bankruptcy indices may be similar to the one depicted in FIG. 3.

Different indices could be created, such as an index of a particular number of companies, an index of all companies in a particular industry, or an index of all companies having a particular market capitalization—i.e., total dollar value of all outstanding shares of a company, below a certain amount. An index may even be created for a user configurable group of companies.

Each bankruptcy index could be created using data such as the stock prices of the component companies or a fixed weighting of the stock prices multiplied by a “bankruptcy multiplier” that details the stage of bankruptcy a component firm is in (Solvent, Chapter 7, Chapter 11). The bankruptcy multiplier could also be linked to a number of standard or user configurable “credit events” that would be indicative to investors of greater financial risk.

The index could also be created using data from a series of company-issued bond prices, to provide indices on a selection of individual company debt obligations, as a natural hedge to credit default swaps. All of this data, along with the bankruptcy multiplier could be combined according to a suitable algorithm to form the index.

The bankruptcy multiplier could be set such that a single bankruptcy or similar major credit event would significantly affect the entire index. This effect would be disproportionately greater than the effect the bankruptcy would have on the index as a function of the lowered stock price of the bankrupted company. Within the index, each company may be weighted equally or unequally. While a bankruptcy or a major credit event may significantly affect the index irrespective of the company at issue, the effect of a minor credit event of one company in the index would depend on its weighting.

A futures contract on a bankruptcy index would be a binding agreement between two parties to buy and sell the cash value of the index on a future date. For example, there may be created a series of futures contracts with monthly expiration dates on an index of certain companies known as “Index A.” The seller of, for instance, a Nov. 30, 2001 “Index A” contract would collect a certain amount of money at the time of sale. Market forces would set the amount collected at the time of sale. In selling the futures contract, the seller has agreed to pay a buyer of that contract an amount of money equal to the cash value of “Index A” on Nov. 30, 2001. These contracts may be traded on an electronic exchange. If, in this case, “Index A” fell in value due to impending bankruptcy, the seller would have to pay the buyer an amount less than what he received and would earn a profit. If on the other hand, the value of “Index A” increased due to an improved financial outlook, the buyer would profit.

One potential use of a bankruptcy index is to provide a way to hedge against the risk involved in a credit default swap. In a credit default swap, one party, a bond holder, agrees to make regular payments to a second party. In exchange for those payments, the second party, in effect, provides insurance against the default of the bond issuer. This default protection ensures the first party that, in the event of bankruptcy or other pre-determined credit events, the second party will take possession of the bonds and pay the first party the face value of the bonds plus the interest due at the end of the term. In this example, in the event of a bankruptcy, the second party could be exposed to a large amount of liability. The systems and methods of this invention allow the second party to minimize liability by selling futures contracts on a bankruptcy index. Even if only one company in the index goes bankrupt, the price of the index would be substantially affected. This substantial change in the value of the bankruptcy index would result in a profit on the futures contract, and offset the loss associated with the default.

Another possible use for futures and/or options contracts based on a bankruptcy index is to protect the retirement funds of corporate employees. It is a common practice for corporations to induce their employees to purchase and hold the company's stock in their 401(k) or other retirement plans. These inducements come in the form of discounts, matching programs, and options. As such, many corporate employees' portfolios are heavily leveraged to their own company's stock. If the company goes bankrupt or announces a major credit event, the value of the stock could plummet, thereby severely lowering the value of the employees' retirement funds. By allowing employees to trade futures and options contracts on a bankruptcy index tied to the performance of the company, or by trading these contracts on behalf of the employees, the risk of an employee losing a significant portion of retirement savings is reduced.

Another system and method of the invention would allow the creation of a user configurable bankruptcy index tied to a specific portfolio. This would give individual investors and fund managers the opportunity to hedge against the risk of bankruptcy of any of the companies in which they invest. This would greatly simplify their hedging strategy. By trading futures and/or options contracts on a user configurable bankruptcy index, an individual or a fund manager can protect his or her investments from unforeseen bankruptcies or major credit events of any company in his or her portfolio by making a single transaction. This user configurable bankruptcy index could be created manually by individually selecting the companies and their respective weights in the index. Alternatively, company and weight selection could be performed automatically to conform to an existing portfolio. The user configurable bankruptcy index could also be created by a combination of an automatic and manual selection process. These examples are meant to be illustrative of a few ways to utilize a bankruptcy index and are not meant to limit the scope of the systems and methods of the present invention.

Accordingly, systems and methods for providing liquidity and distribution networks for non-traditionally traded items are provided. It will be understood that the foregoing is merely illustrative of the principles of the invention and that various modifications can be made by those skilled in the art without departing from the scope and spirit of the invention, with is limited only by the claims that follow.

1. A method for creating an intellectual property assets index for the support of futures or options contracts comprising:
electronically capturing intellectual property assets data from selected sources;
electronically compiling the intellectual property assets data;
electronically sorting the intellectual property assets data; and
electronically updating the intellectual property assets data to form an intellectual property assets index.

2. The method of claim 1, wherein the intellectual property assets index is based on a particular group of companies.

3. The method of claim 2, wherein the particular group of companies is a group of companies in substantially the same industry.

4. The method of claim 2, wherein the particular group of companies is a group of companies having a particular market capitalization.

5. The method of claim 1, wherein the intellectual property assets index is based on a user configurable group of companies.

6. The method of claim 5, wherein the user configurable group of companies is based on an existing portfolio.

7. The method of claim 1, wherein the intellectual property assets data comprises the number of citations to a patent by a national patent office.

8. The method of claim 1, wherein the intellectual property assets data comprises the number of patents issued to an entity by a national patent office.

9. The method of claim 1, wherein the intellectual property assets data comprises the age of a patent.

10. The method of claim 1, wherein the intellectual property assets data comprises litigation results.

11. The method of claim 1, wherein the intellectual property assets data comprises licensing contracts.

12. A method for creating a user configurable futures or options contract based on an intellectual property assets index comprising:
selecting an intellectual property assets index;
setting the terms of the user configurable futures or options contract on the intellectual property assets index; and
posting the user configurable futures or options contract on the intellectual property assets index.

13. A method for creating a bankruptcy index for the support of futures or options contracts comprising:
electronically capturing financial data from selected sources;
electronically compiling the financial data;
electronically sorting the financial data; and
electronically updating the financial data to form a bankruptcy index.

14. The method of claim 13, wherein the bankruptcy index is based on a pre-determined group of companies.

15. The method of claim 14, wherein the pre-determined group of companies is a group of companies in the same industry.

16. The method of claim 14, wherein the pre-determined group of companies is a group of companies having a particular market capitalization.

17. The method of claim 13, wherein the bankruptcy index is based on a user configurable group of companies.

18. The method of claim 17, wherein the user configurable group of companies is based on an existing portfolio.

19. The method of claim 13, wherein the financial data comprises stock prices.

20. The method of claim 13, wherein the financial data comprises credit status.

21. The method of claim 13, wherein the financial data comprises bond prices.

22. The method of claim 13, wherein the financial data comprises debt obligations.

23. The method of claim 13, wherein the compiling comprises multiplying the financial data by a bankruptcy multiplier, the bankruptcy multiplier based on a credit event.

24. The method of claim 13, wherein the compiling comprises applying a set algorithm designed such that the effect of a bankruptcy on the bankruptcy index would be disproportionately greater than the effect the bankruptcy would have on the bankruptcy index as a function of a lowered stock price of a company on which the financial data is based.

25. A method for creating a user configurable futures or options contract based on a bankruptcy index comprising:
selecting a bankruptcy index;
setting the terms of the user configurable futures or options contract on the bankruptcy index; and
posting the user configurable futures or options contract on the bankruptcy index.

26. A system for creating an index for the support of futures or options contracts on intellectual property assets, the system comprising:
an index processor operative to:
electronically capture intellectual property assets data from selected sources;
electronically compile the intellectual property assets data;
electronically sort the intellectual property assets data; and
electronically update the intellectual property assets data to form a intellectual property assets index.

27. The system of claim 26, wherein the intellectual property assets index is based on a particular group of companies.

28. The system of claim 27, wherein the particular group of companies is a group of companies in the same industry.

29. The system of claim 27, wherein the particular group of companies is a group of companies having a particular market capitalization.

30. The system of claim 26, wherein the intellectual property assets index is based on a user configurable group of companies.

31. The system of claim 30, wherein the user configurable group of companies is based on an existing portfolio.

32. The system of claim 26, wherein the intellectual property assets data comprises the number of citations to a patent by a national patent office.

33. The system of claim 26, wherein the intellectual property assets data comprises the number of patents issued to an entity by a national patent office.

34. The system of claim 26, wherein the intellectual property assets data comprises the age of a patent.

35. The system of claim 26, wherein the intellectual property assets data comprises litigation results.

36. The system of claim 26, wherein the intellectual property assets data comprises licensing contracts.

37. A system for creating a user configurable futures or options contract based on an intellectual property assets index comprising:
a server storage device;
a server processor connected to the server storage device, the server storage device storing a program for controlling the server processor;
a plurality of workstations, each of the plurality of workstations operative to communicate with the server, each of the workstations comprising:
a workstation storage device;
a workstation processor connected to the workstation storage device, the workstation storage device storing a workstation program for controlling the workstation processor, the workstation processor operative with the workstation program to:
select an intellectual property assets index;
set the terms of the user configurable futures or options contract on the intellectual property assets index; and
post the user configurable futures or options contract on the intellectual property assets index.

38. A system for trading futures or options contracts on a bankruptcy index comprising:
a storage device;
a processor connected to the storage device, the storage device storing a program for controlling the processor, the processor operative with the program to:
create a bankruptcy index; and
post a futures or options contract based on the bankruptcy index.

39. A system for creating a bankruptcy index for the support of futures or options contracts, the system comprising:
an index processor operative to:
electronically capture financial data from selected sources;
electronically compile the financial data;
electronically sort the financial data; and
electronically update the financial data to form a bankruptcy index.

40. The system of claim 39, wherein the bankruptcy index is based on a particular group of companies.

41. The system of claim 40, wherein the particular group of companies is a group of companies in the same industry.

42. The system of claim 40, wherein the particular group of companies is a group of companies having a particular market capitalization.

43. The system of claim 39, wherein the bankruptcy index is based on a user configurable group of companies.

44. The system of claim 43, wherein the user configurable group of companies is based on an existing portfolio.

45. The system of claim 39, wherein the financial data comprises stock prices.

46. The system of claim 39, wherein the financial data comprises credit status.

47. The system of claim 39, wherein the financial data comprises bond prices.

48. The system of claim 39, wherein the financial data comprises debt obligations.

49. The system of claim 39, wherein the compiling comprises multiplying financial data by a bankruptcy number.

50. The system of claim 39, wherein the compiling comprises applying a set algorithm designed such that the effect of a bankruptcy on the bankruptcy index would be disproportionately greater than the effect the bankruptcy would have on the bankruptcy index as a function of a lowered stock price of a company on which the financial data is based.

51. A system for creating a user configurable futures or options contract based on a bankruptcy index comprising:
a server storage device;
a server processor connected to the server storage device, the server storage device storing a program for controlling the server processor;
a plurality of workstations, each of the plurality of workstations operative to communicate with the server, each of the workstations comprising:
a workstation storage device;
a workstation processor connected to the workstation storage device, the workstation storage device storing a workstation program for controlling the workstation processor, the workstation processor operative with the workstation program to:
select a bankruptcy index;
set the terms of the user configurable futures or options contract on the bankruptcy index; and
post the user configurable futures or options contract on the bankruptcy index.
